(19) United States
(12) Patent Application Publication
(10) Pub. No.: US 2009/0283002 A1
(43) Pub. Date: Nov. 19, 2009

(54) Method for printing correction

(76) Inventor: Stephan Schultze, Lohr (DE)

Correspondence Address: STRIKER, STRIKER & STENBY, 103 East Neck Road, Huntington, NY, 11743, US

(21) Appl. No.: 12/486,953

(22) Filed: Jun. 18, 2009

Related U.S. Application Data
(63) Continuation-in-part of application No. 11/511,935, filed on Aug. 29, 2006.

(30) Foreign Application Priority Data
Sep. 2, 2005 (DE) 10 2005 041 651.9

(51) Int. Cl. B41F 1/66

(52) U.S. Cl. 101/484

(57) ABSTRACT

A method for printing correction using a register control unit for a multicolor printing press equipped with at least one printing station having at least on printing cylinder for performing a printing procedure on a printing material, includes per printing procedure printing at least two printing regions and for each printing region at least one respectively associated printing mark on the printing material using the at least one printing cylinder, detecting the position of at least one printing mark per printing region using at least one sensor, executing an evaluation in the register control unit by comparing each detected position of a printing mark with a respective reference position in order to control a relative movement of the printing material to the printing cylinder. Alternatively, the method includes per printing procedure printing at least two printing regions on the printing material by the at least one printing cylinder, defining for each printing region at least one region to be evaluated, detecting said at least one region to be evaluated using at least one sensor, and generating image data, executing an evaluation in the register control unit by comparing each generated image data with a respective reference data in order to control a relative movement of the printing material to the printing cylinder.

This application is a continuation-in-part of U.S. patent application Ser. No. 11/511,935 filed on Aug. 29, 2006. This U.S. patent application, whose subject matter is incorporated herein by reference, provides the basis for a claim to priority under 35 USC 119(e).

The invention described and claimed hereinbelow is also described in German Patent Application DE 10 2005 041 651.9 filed on 2 Sep. 2005. This German Patent Application, whose subject matter is incorporated herein by reference, provides the basis for a claim of priority of invention under 35 U.S.C. 119(a)-(d).

### BACKGROUND OF THE INVENTION

The present invention generally relates to a method for printing correction.

More particularly, the present invention relates to a method for printing correction using a register control unit for a multicolor printing press equipped with individual printing stations, each printing station having a printing cylinder for printing on a printing material, the printing material being relatively moved to the printing cylinder in order to effect a printing correction, e.g. a length correction and/or a position correction.

In multicolor printing in printing presses, particularly in rotary printing presses, the individual colors, in particular cyan, magenta, yellow, and black, are applied onto a printing material in subsequent printing stations. The printing material is usually provided in the form of a web and is conveyed endlessly through the printing unit. For the final print quality achieved, it is crucial that the print images of the individual colors be precisely congruent to one another. The congruence of the print images in relation to one another is referred to as the register. In order to align the individual printing stations with one another, in addition to the actual print image, each printing station also prints register measurement marks or so-called printing marks, for example in the form of register crosses. An optical measurement system can then use these marks for online detection of an offset between the individual print images. Alternatively to the printing of marks, these errors in the print image can be detected by means of a print image detection with image evaluation.

In rotary printing systems, this measurement system is generally a component of the control system, the so-called register control unit. The register control unit manipulates the printing process by means of suitable actuators and compensates for register deviations detected by the optical measurement system. In particular, the actuators can change the web length of the printing material between succeeding printing stations so that the print images of succeeding printing stations are congruent to one another.

In addition to the relative position of the printing stations to one another, the causes for deviations between the individual printing procedures include changes in the geometry of the printing material. For example, these geometrical changes are caused by the influence of moisture and by the presence of drying steps between the printing stations. The challenge increases when the printing material is at least partially elastic.

During the printing process, the web tension is kept as uniform as possible, making it possible to achieve favorable printing quality without significant corrections. The control parameters of the register control are adapted to this operating state. But both positive and negative accelerations cause the web tension to change, negatively influencing the register precision. Most often, the control system is unable to sufficiently compensate for this, leading to a corresponding waste rate in this operating phase. Even after the acceleration phase, the control system needs a certain amount of running time in order to achieve the suitable set values once more. This can also generate waste.

DE 40 37 728 C1 describes an apparatus for register control of multicolor roller/rotary printing presses according to the web-to-web method, having a controller equipped with a central unit for detecting and storing all control parameters and the control behavior and having a scanning device for detecting web register marks and actuators for controlling the longitudinal register. The apparatus includes a monitoring unit equipped with an acceleration detection unit that detects a speed change in the printing cylinders of the printing press, which deviates from a stable web speed, and has a shut-off device that communicates via signals with the acceleration detection unit and in response to a signal representing this speed change, interrupts the control action until a constant operating speed is achieved again.

U.S. Pat. No. 6,591,746 B2 discloses a printing press being provided with a first rotatable printing roller that prints ink of a first color on a web of material and causes a first pair of registration marks to be periodically printed in the first color on the web, a second rotatable printing roller that prints ink of a second color on the web of material and causes a second pair of registration marks to be periodically printed in the second color on the web, a third rotatable printing roller that prints ink of a third color on the web of material and causes a third pair of registration marks to be periodically printed in the third color on the web, an imaging device positioned to detect the registration marks printed on the web that generates image data representing the registration marks, and a controller operatively coupled to the printing rollers and the imaging device. Using pairs of registration marks per color allows for detecting a misalignment of one pair of registration marks relative to another pair of registration marks by determining whether or not the centers of each pair of registration marks coincide with each other.

In operations that use flexible printing plates, the mounting of the printing plate causes a flexing in the material flow direction. This is the case, for example, with flexographic clichés that are flexible in a rubber-like fashion and therefore elastic.

In addition, the modulus of elasticity depends on the cliché thickness, which varies as a function of the pattern to be printed. As a result, a constant elastic force generates a flexing of the cliché in the printing direction on the printing cylinder, which flexing depends on the cliché thickness and therefore the printing pattern. Therefore, the image printed on the material can be distorted. The same phenomenon occurs when the processing printing plates cannot be produced precisely enough and/or are subjected to powerful production fluctuations within the format. This complicates the task of positioning print images exactly in relation to one another.

Up to now, a maximum of one single print correction was executed per format and print. Test prints are measured manually to determine the necessary correction value, which is manually input into the control system. It has turned out, however, that these procedures are not sufficiently precise, particularly in the case of flexible printing clichés having more than one printing region.

It is therefore desirable to create a method for printing correction that compensates for production tolerances in these printing clichés and compensates for errors in the mounting of these printing clichés.

### SUMMARY OF THE INVENTION

The object of the invention is attained in that at least one first printing mark and one second printing mark are printed per product and per printing procedure and, for register control purposes, their positions are compared to reference positions and/or the register control is executed based on a comparison between image data, which are obtained from a print image detection, and comparison image data or reference data. This method makes it possible to compensate for production tolerances, particularly in the case of flexible printing clichés, and to compensate for errors in the mounting of such printing clichés. It is also possible to effectively correct for distortions that can occur due to varying heights of the clichés.

According to a first aspect of the invention, there is provided a method for printing correction using a register control unit for a multicolor printing press equipped with at least one printing station having at least on printing cylinder for performing a printing procedure on a printing material. At least two printing regions and for each printing region at least one respectively associated printing mark are printed on the printing material per printing procedure using the at least one printing cylinder. The position of at least one printing mark per printing region is detected using at least one sensor. An evaluation is executed in the register control unit by comparing each detected position of a printing mark with a respective reference position in order to control a relative movement of the printing material to the printing cylinder.

A relative movement of the printing cylinder to the printing material means that the tangential velocity of the printing cylinder differs from the linear velocity of the printing material. Starting from a synchronous movement of the printing cylinder and the printing material, i.e. the tangential speed of the printing cylinder being equal to the linear speed of the printing material, the tangential speed of the printing cylinder and/or the linear speed of the printing material can be changed in order to achieve a relative movement.

If additional printing marks are printed per printing procedure and these are evaluated for register control purposes, then this enables better detection and correction, even of complex distortions, particularly those that are of a higher order, i.e. nonlinear. Each printing mark can serve as a node for calculating a function representing a complex distortions, e.g. a polynomial.

In a preferred method variant, the printing marks are scanned automatically. This permits an automatic register control in which it is possible to make corrections to several regions per format.

According to a second aspect of the invention, there is provided a method for printing correction using a register control unit for a multicolor printing press equipped with at least one printing station having at least on printing cylinder for performing a printing procedure on a printing material. At least two printing regions are printed on the printing material per printing procedure using the at least one printing cylinder. At least one region to be evaluated is defined for each printing region. Said at least one region to be evaluated is detected by at least one sensor, and image data is generated. An evaluation is executed in the register control unit by comparing each generated image data with a respective reference data in order to control a relative movement of the printing material to the printing cylinder.

In this connection, the printing material can be divided into a plurality of regions to be evaluated. These can, for example, be a plurality of cliché regions in which the cliché produces a print, i.e. comes into contact with the printing material.

In one variant of the method, the regions to be evaluated are situated within a printing region and/or outside the printing region. This enables a particularly flexible adaptation to the printing patterns.

If regions to be evaluated are detected in a device by means of one or more cameras connected to an image data generation unit, then in lieu of a fixed number of printing marks, the entire printing region can serve as a region to be evaluated so that the rolling-off of the printing plate can be pre-distorted in accordance with processing errors of the printing cliché and/or in accordance with mounting errors of the cliché, thus yielding an optimum print on the whole.

In one method variant, the correction is carried out by adapting the position of the printing station for which the respective printing marks or regions to be evaluated were evaluated. This permits an optimum alignment for the next printing procedure.

Alternatively or in addition to this, the correction is carried out by adapting the position of the printing stations that are situated in a material flow direction after the printing station for which the respective printing marks or regions to be evaluated were evaluated. This does not in fact optimize the absolute print. It is advantageous, however, that the different printing stations can be corrected in relation to one another, which is of particular interest in multicolor printing in which, for example, the four basic colors cyan, magenta, yellow, and black must be adjusted very precisely in relation to one another.

If the correction is carried out within predeterminable correction regions on the printing material, then this offers the advantage that the correction can be selectively carried out, for example, outside of the printing region. This prevents a “smearing” of the print. It is also possible to shift the correction regions into the printing regions in which a small correction interferes only slightly, thus having only a minimal effect on the printing result.

In a preferred use of the method, the method is used to print paper, cardboard, corrugated cardboard, plastic or metal foil, wood, fabrics, or metals by means of flexible and/or elastic printing clichés. The above-described advantage is achieved for these uses in particular because the problems mentioned above often occur in these kinds of printing.

If flexographic clichés are used as the printing clichés, which is in particular the case with the direct printing of corrugated cardboard, the correction method can also be used to effectively carry out corrections for distortions that can occur particularly with the use of flexographic clichés.

In another preferred use of the method, when a plurality of printing stations are to be controlled in relation to one another, a first print without correction is initially executed in a first printing station and all of the correction values are checked for possible print length reductions and are modified together with the print of the first printing station in a manner that prevents print length reductions. This is particularly advantageous with regard to the printing of paper or corrugated cardboard in which—in certain cases—critical print length reductions can occur, which can have particularly serious repercussions on the print image. This method variant does not in fact achieve absolute printing precision. But the printing stations remain error-free in relation to one another, without the occurrence of critical print length reductions. A corresponding method for avoiding print length reductions is disclosed in U.S. Pat. No. 7,337,035 B2, which is completely incorporated herein by reference.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic representation of a multicolor printing press equipped with individual printing stations and a register control unit for carrying out the method according to the present invention,

FIG. 2 schematically depicts a movement profile, with and without print length correction,

FIG. 3 schematically depicts a segment of a printing material with two printing marks,

FIG. 4 schematically depicts a movement profile for correction of a printing product according to FIG. 3,

FIG. 5 schematically depicts a segment of a printing material with a plurality of printing marks, and

FIG. 6 schematically depicts a printing product comprising a printing region, a region to be evaluated an a printing mark.

### DESCRIPTION OF THE PREFERRED EMBODIMENTS

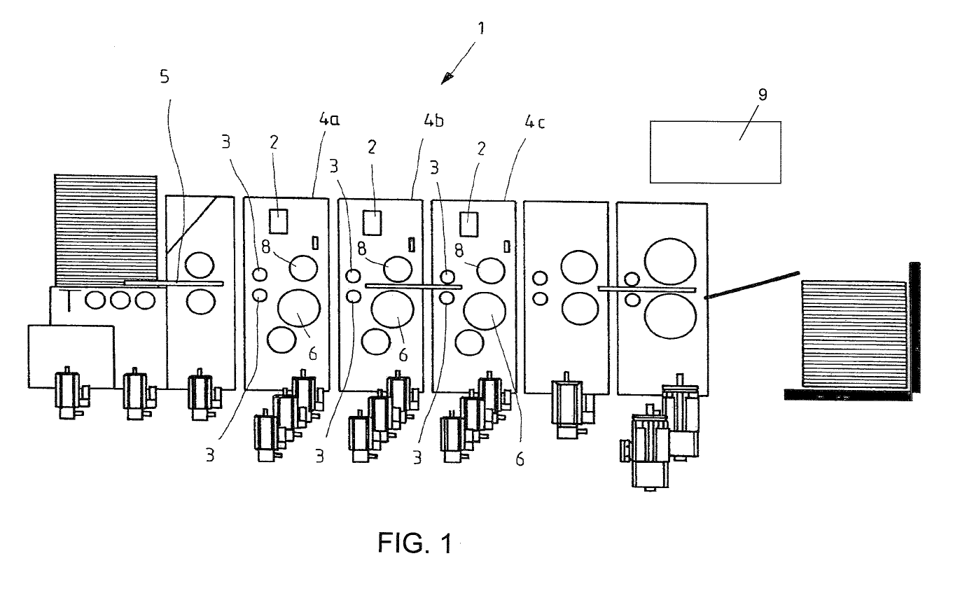

FIG. 1 shows a multicolor printing press 1 equipped with individual printing stations 4a, 4b, 4c and a register control unit 9 for carrying out the method according to the present invention. Printing press 1 includes a plurality of printing stations 4a, 4b, 4c in which a printing product 5 is printed on in each case by a printing cylinder 6 cooperating with an impression cylinder 8. With the aid of transportation devices 3, printing product 5 is transported by a printing station 4a, 4b, 4c to a respective next printing station 4a, 4b, 4c. A device 2 comprising a sensor or a camera is used for recording and evaluating the positions of printing marks on the printing products 5. Device 2 may be, for instance, a light barrier, a printing mark sensor, a camera and a computing unit which are used for generating and supplying ascertained position data or image data, respectively, to register control unit 9. Based on the position data or image data, respectively, register control unit 9 is able to apply printing regions together with their associated printing marks onto printing products 5 according to position in a variable manner.

Printing stations 4a, 4b, 4c as well as transportation devices 3 may be used as actuators of the method according to the present invention. In the first case, the transportation of printing product 5 takes place with the aid of transportation device 3 using a largely constant speed, at least one printing cylinder 6 of printing stations 4a, 4b, 4c executing a relative movement to printing product 5. In the second case, the transportation of printing product 5 takes place with the aid of one or more transportation devices 3 using a speed that is not constant. The result is that the transportation procedure of printing product 5 is corrected, which may be done, for instance, by the correction of a speed control for transportation devices 3.

Advantageously, there are two different possibilities for the selection of the correction actuators; particularly in the case of single products, the product transportation devices being used as actuator as opposed to correction of printing cylinders 6. This also corresponds to a selection possibility in usual register correction methods.

In the following, a printing correction including a printing length correction is described in principle. This type of a printing length correction is based on the fact that errors in the printing lengths are corrected in a printing-free region, through the execution of a correcting movement.

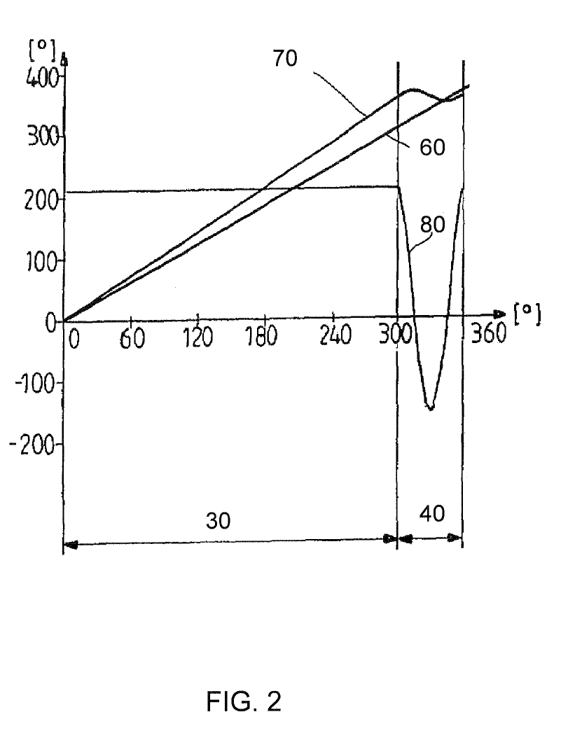

FIG. 2 shows a representation in principle of a printing length correction. In the diagram, on the x axis, an angle of the master axis of a printing station is plotted. On the y axis, an angle of a printing cylinder of the same printing station is plotted. Usually, the angle of the master axis is set by the control unit and the working angles of the axles of the printing station are adjusted relative to this master axis, if necessary. In the present example, the master axis is set to correspond to the angle of a constantly rotating printing cylinder.

A region 30 on the x axis defines a printing region, and a region 40 on the x axis defines a printing-free region of the printing station, that is, a region in which no printing on the printing product is carried out. Within a printing-free region there is no contact between the printing cylinder comprising a mounted flexographic printing plate or cliché and the printing material, either because the printing product has already left the printing station, or the printing plate or cliché does not have a printing pattern in certain zones. It is suitable to carry out corrections in these regions because this prevents “smearing” of the print. There are therefore no repercussions on the transport process of the printing material.

An essentially linear curve 60 represents an uncorrected curve of the angle of the printing cylinder plotted against the angle of the master axis. In this curve, the two angles run synchronously to each other, so that thereby identical speeds of a printing product driven by the transportation devices and of a printing cylinder having a mounted printing plate or cliché are attained. This may be seen in the diagram in that the master axis has executed a complete revolution (360°) at the same time as the printing cylinder.

A curve 70 is a curve representing the angle of the printing cylinder corrected for printing length plotted against the master axis angle. Curve 70 is steeper than curve 60, and thus, the printing cylinder achieves a full rotation earlier than the machine angle. FIG. 2 shows that the printing cylinder has performed approximately one full rotation (from 0° to 360°) at a point in time at which the master axis has rotated only from 0° to 300°. This means that the printing cylinder rotates at a higher tangential velocity than the transportation devices (i.e. the linear velocity of the printing material). As a result of this different tangential velocities, a relative movement develops between the printing cylinder comprising the mounted flexographic printing plate or cliché, and the printing product. It is true that, because of this, an increased wear of the printing plate or cliché is created by friction, but on the other hand the actual printing length of the flexographic printing plate or cliché advantageously equals the intended printing length.

In FIG. 2, a speed curve of the motion of the printing cylinder according to curve 70 is shown as curve 80. In region 40, the printing cylinder having the printing plate or cliché is position-corrected in such a way that, at the beginning of the next printing region at 360° or 0°, in common with the master axis, it takes up a specified common position again. It is shown in FIG. 2 that the printing cylinder executes a breaking motion in the printing-free region 40 (negative slope of curve 70). This has the result that the speed curve 80 of the correction motion of the printing cylinder briefly goes into negative area, that, in fact, printing cylinder and printing material have opposite velocities. Normally, however, the speed curve remains completely in positive area, which means that the tangential velocity of the printing cylinder has the same sign as the linear velocity of the printing material.

In curve 60 of FIG. 2, a relative movement between the printing material and the printing cylinder is carried out within the printing region 30 and the printing-free region 40. Thus, the printing region 30 and the printing-free region 40 are defined as correction regions. If the printing plate is in constant contact with the printing material, as is the case, for example, in offset printing, then it is preferable, as regards the image to be printed, to select correction regions in which the correction has a minimal effect on the process and on the printing result. In general, only very slight corrections are possible since otherwise, the correction procedure has negative repercussions on the transport of the printing material 5, e.g. generates fluctuations in web tension.

In the design according to the present invention, at least two printing marks are printed per printing procedure and these are compared to reference positions for register correction purposes. This can occur, for example, through a comparison to a master axis angle position. Especially, a printing procedure is defined to be at most a complete revolution of a printing cylinder. Instead of detecting the positions of printing marks, an image evaluation could be carried out. Therefore, the printing material is divided into a plurality of regions to be evaluated. These can, for example, be a plurality of cliché regions in which the cliché produces a print, i.e. comes into contact with the printing material. For example, there are also regions in which the cliché does not come into contact with the printing material.

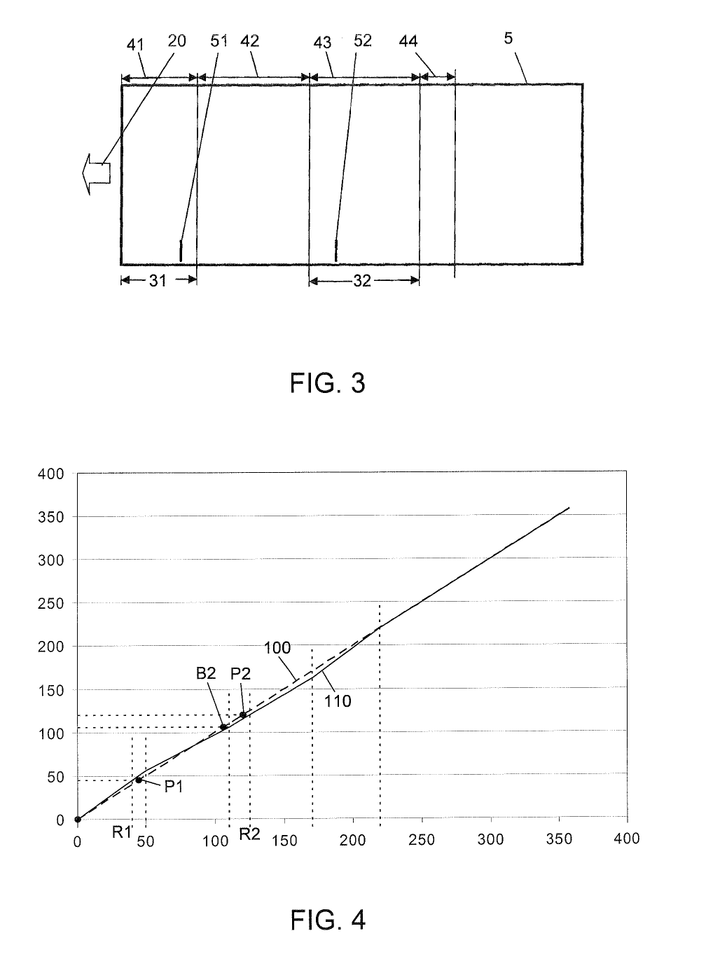

According to one preferred embodiment of the invention, at least two corrections according to FIG. 2 can be carried out per printing procedure. This is explained in further detail referring to FIGS. 3 and 4.

FIG. 3 schematically depicts an example of a printing product 5 that has a first printing region 31 having an associated printing mark 51, and a second printing region 32 having an associated printing mark 52. The material flow direction is indicated by numeral 20. The leading edge of each printing product 5 coincides with master axis angle 0° or 360°. The printing regions 31, 32 on the material are defined by corresponding printing patterns on a printing plate or cliché. There are printing-free regions outside of the printing regions 31, 32. The printing-free regions are defined by printing-pattern-free zones on the printing plate or cliché. As the mounting of the printing plate or cliché onto the printing cylinder causes a flexing or distortion in the material flow direction, the sizes of the printing regions 31 and 32, and of the printing-free regions therein between are not as intended. Thus a correction of the movement of the printing cylinder relative to the master axis is necessary.

In the following, the sequence of the method according to the present invention in printing press 1 is described in principle, referring especially to FIGS. 3 and 1.

Printing product 5 is conveyed to first printing station 4a using transportation device 3. In first printing station 4a, first printing region 31 including first printing mark 51 and second printing region 32 including second printing mark 52 are applied. Device 2 detects the positions of printing marks 51, 52 indicating the position of the associated printing regions 31 and 32, respectively. Device 2 cooperates with register control unit 9, which in turn executes an evaluation by comparing the positions of printing marks 51, 52 with pre-defined reference positions. E.g., the reference positions could be master axis angles set by an operator or detected positions of printing marks printed by an anteceding printing station. If it is established that the positions of printing marks 51 and 52 deviate from the reference positions, this means that a printing correction is necessary.

An example of an embodiment of a method for printing correction for a printing product 5 according to FIG. 3 is shown in FIG. 4. In the diagram, on the x axis, the master axis angle of printing station 4a is plotted. On the y axis, the angle of the printing cylinder 6 of the printing station 4a is plotted. The reference position R1 of printing mark 51 is set to 400, e.g. by an operator, and the reference position R2 of printing mark 52 is set to 125°, as the first printing region 31 is to be positioned between 0° and 50°, and the second printing region 32 is to be positioned between 110° and 170°.

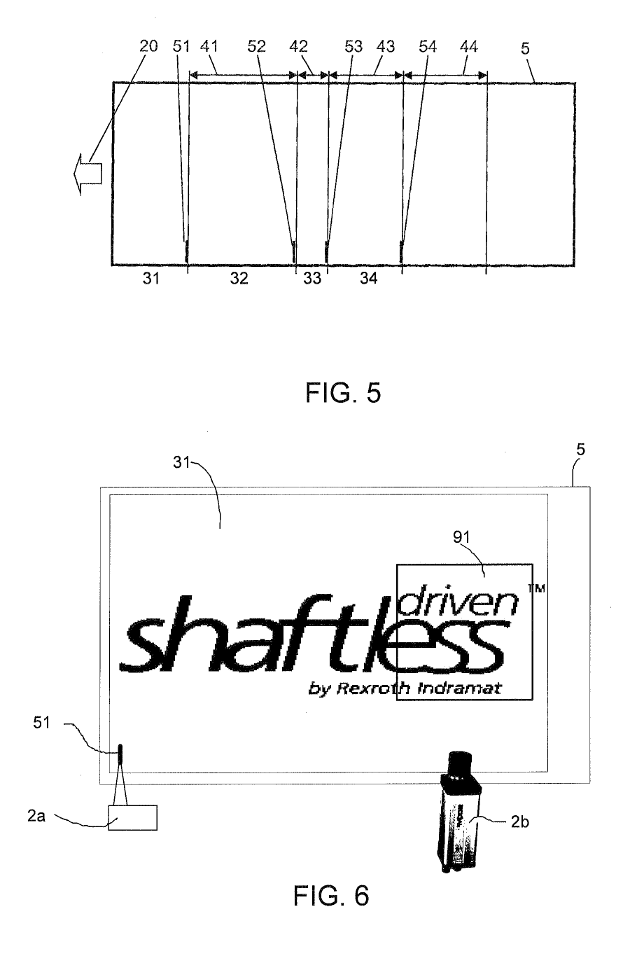

In a first printing procedure (i.e. printing of a first color onto the printing material), the printing cylinder is moved synchronously with master axis in order to detect the uncorrected positions of the printing marks and the printing regions. This uncorrected curve is indicated by 100. The movement of the printing cylinder relative to the master axis, which is necessary to correct the distortions, is determined by comparing the detected positions of the printing marks to the reference positions. In the present example, the detected position P1 of printing mark 51 is 450 and the detected position P2 of printing mark 52 is 120°. Furthermore, the leading edge B2 of the second printing region 32 is also detected by the device 2 and is 1060°. This edge could also be marked by a printing mark (cf. FIG. 5). As the intended size of the undistorted printing regions is known (as indicated on the x axis), the trailing edges of the printing regions 31 and 32 can be calculated assuming a linear flexing of the cliché within the corresponding regions. Based on this, a corrected movement of the printing cylinder can be calculated. The corresponding curve in FIG. 4 is indicated by 110. The printing cylinder rotates faster than the master axis between 0° and 50° in order to apply an undistorted printing region 31 onto the printing product 5. Between 50° and 110° (printing free zone), the printing cylinder rotates slower than the master axis in order to correctly position the leading edge of the second printing region 32. Between 110° and 170°, the printing cylinder rotates also slower than the master axis in order to apply an undistorted printing region 32 onto the printing product 5. Between 170° and 220°, the printing cylinder rotates faster than the master axis in order to reach a synchronous position at 220°. Between 220° and 360°, the printing cylinder rotates synchronously with the master axis in order to correctly position the leading edge of the first printing region 31. The regions within the diagram, wherein a relative movement between the printing cylinder and the printing material occurs, are defined as correction regions 41, 42, 43, 44.

FIG. 5 schematically depicts another example. The printing material 5 in this case has a first printing region 31, followed by a second printing region 32, followed by a third printing region 33, followed by a fourth printing region 34. Each printing region comprises an associated printing mark 51, 52, 53, 54.

The printing regions can, for example, differ in the printing pattern causing a different flexing of the cliché in each printing region. The flexing or distortion of the printing regions is corrected using a method as described with reference to FIGS. 3 and 4.

In a first printing procedure, the printing cylinder is moved synchronously with the printing product 5, i.e. the master axis, in order to detect the current positions of the printing marks 51, 52, 53, 54. The detected positions of the printing marks are compared with pre-defined reference positions. Based on the detected deviations of the detected positions from the reference positions, the movement of the printing cylinder relative to the printing product is calculated. In the present example, the detected position of printing mark 51 coincides with the corresponding reference position. No correction of printing region 31 is thus necessary. However, the detected positions of the printing marks 52, 53, and 54 differ from their corresponding reference positions necessitating a correction. Thus, during the same printing procedure, the printing cylinder moves relative to the printing product within the correction regions 41, 42, 43, and 44, in order to apply undistorted printing regions 32, 33, and 34, and to correctly position the printing region 31 onto the following printing product. The type and the calculation of the correction movement has already been described in reference to FIGS. 2 and 4.

The methods described above can be used to correctly position the printing regions of a subsequent printing station 4b, 4c, e.g., if the reference positions for theses subsequent printing stations are set to the detected positions of the printing marks applied by the printing station 4a. Alternatively to the printing marks used for evaluating the printing regions as described above, regions to be evaluated can be defined for each printing region in order to determine the size, borders and distortions of the printing regions. A camera can be used to record the region to be evaluated. The recorded data are evaluated to generate image data using a data generating unit, which image data are to be compared with reference data characterizing the intended printing image. The data generating unit is advantageously included in the camera or in the register control unit. According to an embodiment, a complete printing region is defined as a region to be evaluated. When an image evaluation is used instead of the evaluation of printing marks 51, 52, 53, 54, then in lieu of using a linear regression for calculating the flexing, it is possible to use curved or higher order correction movements within a correction region, thus making it possible, through the correction movement, to distort the rolling-off of the printing plate so as to produce an optimal print result. The same applies, if more than one printing mark is used per printing region.

A printing product 5 comprising a printing region 31, a region to be evaluated 91 and a printing mark 51 is schematically shown in FIG. 6. In the present example, the region to be evaluated 91 is situated inside the printing region 31. However, a person skilled in the art will readily acknowledge that the region to be evaluated can completely cover the printing region. The printing mark 51 can be detected by a device 2a comprising a light source, e.g. a LED, and a photodiode to detect the amount of reflected light. The region to be evaluated can be detected by a camera 2b. It is understood that one or both of a printing mark and a region to be evaluated can be evaluated per printing procedure.

Another variant of the method provides a correction of the subsequent printing stations. Instead of correcting the printing station whose print image has been evaluated, it is also possible to correspondingly correct the position of all of the subsequent printing stations, especially, by setting their reference positions to the actual printing mark positions of the anteceding station. This option can be expanded to include also correcting the printing station that prints the print image to be evaluated, but this only affects the subsequent printing procedure of the next product.

It is possible to achieve a particularly rapid correction if the evaluation unit, for example a mark reader or a camera system, is connected directly to the correcting drive unit, the actuator. But this option cannot be combined with the options of correcting the subsequent printing stations or with the correction of printing stations and subsequent printing stations.

Another option is to optimize the actuation algorithm by means of a control or actuation that acts on the printing station. If a plurality of printing stations are controlled in relation to one another, then it is possible that some of the adjustments result in print length reductions, i.e. faster movement of the printing cylinder, or print length increases, i.e. slower movement of the printing cylinder. But print length reductions in particular can have very serious repercussions on the print image. Consequently, this option is advantageously provided with the following sequence:
It is assumed that first, a print is made in a first station, which is initially printed without correction.
All of the correction movements calculated from this are then checked for possible print length reductions, which have a particularly critical effect on the overall print result.
If print length reductions occur, then the print is not executed, but instead, the correction movements are modified so that no length reductions occur.

This is not in fact able to achieve absolute printing precision, but the printing stations remain error-free in relation to one another and the critical print length reductions are prevented.

In particular, the above-described method and its variants make it possible to compensate for distortions of the kind that can occur when using flexographic printing clichés for printing paper, cardboard, corrugated cardboard, plastic or metal foil, wood, fabrics, or metals. This makes it possible on the one hand to correct for the production tolerances of printing clichés, which can vary depending on the cliché height, and on the other hand, allows for the correction of possible mounting errors due to a partially varying stretching of the cliché.

It will be understood that each of the elements described above, or two or more together, may also find a useful application in other types of constructions differing from the types described above.

While the invention has been illustrated and described as embodied in a method for printing correction, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for printing correction using a register control unit for a multicolor printing press equipped with at least one printing station having at least one printing cylinder for performing a printing procedure on a printing material, comprising the steps of
per printing procedure printing at least two printing regions and for each printing region at least one respectively associated printing mark on the printing material using the at least one printing cylinder,
detecting the position of at least one printing mark per printing region using at least one sensor,
executing an evaluation in the register control unit by comparing each detected position of a printing mark with a respective reference position in order to control a relative movement of the printing material to the printing cylinder.

2. A method as defined in claim 1; and said printing material being relatively moved to said printing cylinder within at least one correction region defined on the printing material.

3. A method as defined in claim 2; and said at least one correction region being defined on the printing material completely outside of a printing region.

4. A method as defined in claim 2; and said at least one correction region being defined on the printing material at least partially inside of a printing region.

5. A method as defined in claim 1; and further comprising carrying out the printing correction by moving the printing material relatively to the printing cylinder of the printing station for which the respective printing marks were detected.

6. A method as defined in claim 1; and further comprising carrying out the printing correction by moving the printing material relatively to the printing cylinder of at least one of the printing stations that are located in material flow direction behind the printing station for which the respective printing marks were detected.

7. A method as defined in claim 1; and further comprising using the method to print a material selected from the group consisting of paper, cardboard, corrugated cardboard, plastic foil, metal foil, wood, fabrics, and metal by clichés selected from the group consisting of flexible printing clichés, elastic printing clichés, and both.

8. A method as defined in claim 7; and further comprising using flexographic clichés as the printing clichés.

9. A method for printing correction using a register control unit for a multicolor printing press equipped with at least one printing station having at least one printing cylinder for performing a printing procedure on a printing material, comprising the steps of
per printing procedure printing at least two printing regions on the printing material by the at least one printing cylinder,
defining for each printing region at least one region to be evaluated,
detecting said at least one region to be evaluated using at least one sensor, and generating image data,
executing an evaluation in the register control unit by comparing each generated image data with a respective reference data in order to control a relative movement of the printing material to the printing cylinder.

10. A method as defined in claim 9; and said printing material being relatively moved to said printing cylinder within at least one correction region being defined on the printing material.

11. A method as defined in claim 10; and said at least one correction region being defined on the printing material completely outside of a printing region.

12. A method as defined in claim 10; and said at least one correction region being defined on the printing material at least partially inside of a printing region.

13. A method as defined in claim 9; and further comprising situating the regions to be evaluated in a position selected from the group consisting of inside a printing region, outside the printing region, and both.

14. A method as defined in claim 9; and further comprising detecting the regions to be evaluated using one or more cameras connected to a data generation unit generating said image data.

15. A method as defined in claim 9; and further comprising carrying out the correction by moving the printing material relatively to the printing cylinder of the printing station for which the respective region to be evaluated was evaluated.

16. A method as defined in claim 9; and further comprising carrying out the correction by moving the printing material relatively to the printing cylinder of at least one of the printing stations that are situated in material direction after the printing station for which the respective region to be evaluated was evaluated.

17. A method as defined in claim 9; and further comprising using the method to print a material selected from the group consisting of paper, cardboard, corrugated cardboard, plastic foil, metal foil, wood, fabrics, and metal by clichés selected from the group consisting of flexible printing clichés, elastic printing clichés, and both.

18. A method as defined in claim 17; and further comprising using flexographic clichés as the printing clichés.

19. A method as defined in claim 1 or 9; and further comprising, when a plurality of printing stations are provided which are controllable in relation to one another, initially executing a first print without correction in a first printing station; and checking all correction values thus determined for possible print length reductions and modifying together all correction values with the print of the first printing station in a manner that prevents print length reduction.

20. A method as defined in claim 1 or 9; and further controlling the relative movement of the printing material to the printing cylinder includes controlling the tangential velocity of the printing cylinder.

21. A method as defined in claim 1 or 9; and further controlling the relative movement of the printing material to the printing cylinder includes controlling the linear velocity of the printing material.
